(19) United States
(12) Patent Application Publication
(10) Pub. No.: US 2024/0430374 A1
(43) Pub. Date: Dec. 26, 2024

(54) IMAGE PROCESSING APPARATUS, IMAGE PROCESSING SYSTEM, AND IMAGE PROCESSING METHOD

(71) Applicant: PFU LIMITED, Kahoku-shi (JP)

(72) Inventor: Tomoaki Wada, Kahoku-shi (JP)

(21) Appl. No.: 18/737,675

(22) Filed: Jun. 7, 2024

(30) Foreign Application Priority Data
Jun. 21, 2023 (JP) 2023-101985

(51) Int. Cl. H04N 1/00

(52) U.S. Cl. CPC H04N 1/00801; H04N 1/00822; H04N 1/00824

(57) ABSTRACT

An image processing apparatus includes circuitry. The circuitry sets a setting value for each of a plurality of setting items regarding an input image generation process. The circuitry receives designation of one or more setting items on which determination is to be performed as to whether the setting value matches a characteristic of an input image obtained by imaging a medium from among the plurality of setting items. The circuitry acquires the input image. The circuitry performs determination of whether the setting value matches the characteristic of the input image for each of the designated one or more setting items. The circuitry notifies information regarding a result of the determination or control an apparatus that generated the input image to stop an image generation process when the result of the determination indicates that the setting value does not match the characteristic of the input image.

### CROSS-REFERENCE TO RELATED APPLICATION

This patent application is based on and claims priority pursuant to 35 U.S.C. § 119 (a) to Japanese Patent Application No. 2023-101985, filed on Jun. 21, 2023, in the Japan Patent Office, the entire disclosure of which is hereby incorporated by reference herein.

### BACKGROUND

### Technical Field

The present disclosure relates to an image processing apparatus, an image processing system, and an image processing method.

### Related Art

Currently, image processing apparatuses such as a scanner, which scans a plurality of media to generate images while sequentially conveying the media, have been used for imaging of various types of media in a wide variety of applications. The image quality required of such an image processing apparatus differs depending on, for example, its purpose and the type of media to be read. In general, in the image processing apparatus, settings of various items regarding to imaging processing or image processing, such as a size or color, can be configured to generate an appropriate image according to, for example, the application or type of media. However, when a medium that a user does not expect is included in the media to be processed by mistake, an image may be generated according to settings that are not suitable for the medium.

A document reading apparatus that includes image type input means for inputting an image type of a document to be read by a document reading unit, and image type determination means for determining the image type of the document read by the document reading unit is known. When the image type of the document input by the image type input means is different from the image type of the document determined by the image type determination means, the document reading apparatus notifies the user of the difference.

### SUMMARY

In one aspect, an image processing apparatus includes circuitry. The circuitry sets a setting value for each of a plurality of setting items regarding an input image generation process. The circuitry receives designation of one or more setting items on which determination is to be performed as to whether the setting value matches a characteristic of an input image obtained by imaging a medium from among the plurality of setting items. The circuitry acquires the input image. The circuitry performs determination of whether the setting value matches the characteristic of the input image for each of the designated one or more setting items. The circuitry notifies information regarding a result of the determination or control an apparatus that generated the input image to stop an image generation process when the result of the determination indicates that the setting value does not match the characteristic of the input image.

In another aspect, an image processing system includes an image reading apparatus and an information processing apparatus. The image processing system includes circuitry. The circuitry sets a setting value for each of a plurality of setting items regarding an input image generation process. The circuitry receives designation of one or more setting items on which determination is to be performed as to whether the setting value matches a characteristic of an input image obtained by imaging a medium from among the plurality of setting items. The circuitry acquires the input image. The circuitry performs determination of whether the setting value matches the characteristic of the input image for each of the one or more setting items. The circuitry notifies information regarding a result of the determination or control an apparatus that generated the input image to stop an image generation process when the result of the determination indicates that the setting value does not match the characteristic of the input image.

In another aspect, an image processing method includes setting a setting value for each of a plurality of setting items regarding an input image generation process. The image processing method includes receiving designation of one or more setting items on which determination is to be performed as to whether the setting value matches a characteristic of an input image obtained by imaging a medium from among the plurality of setting items. The image processing method includes acquiring the input image. The image processing method includes performing determination of whether the setting value matches the characteristic of the input image for each of the designated one or more setting items. The image processing method includes notifying information regarding a result of the determination or controlling an apparatus that generated the input image to stop an image generation process when the result of the determination indicates that the setting value does not match the characteristic of the input image.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram schematically illustrating a configuration of an image processing system according to an embodiment of the present disclosure;

FIG. 2 is a perspective view of an image reading apparatus of the image processing system illustrated in FIG. 1;

FIG. 3 is a diagram illustrating a conveyance passage inside the image reading apparatus illustrated in FIG. 2;

FIG. 4 is a block diagram schematically illustrating a configuration of the image reading apparatus illustrated in FIG. 2;

FIG. 5 is a schematic diagram illustrating an example data structure of a setting information table;

FIG. 6 is a diagram schematically illustrating configurations of a first storage device and a first processing circuit of the image reading apparatus illustrated in FIG. 4;

FIG. 7 is a block diagram schematically illustrating a configuration of the information processing apparatus of the image processing system illustrated in FIG. 1;

FIG. 8 is a flowchart of an image reading process performed by the image reading apparatus illustrated in FIG. 6;

FIG. 9 is another flowchart of the image reading process performed by the image reading apparatus illustrated in FIG. 6;

FIG. 10 is a schematic diagram illustrating an example of a reception screen;

FIG. 11 is a schematic diagram illustrating an example of another reception screen;

FIG. 12 is a schematic diagram illustrating an example of another reception screen;

FIG. 13 is a schematic diagram illustrating an example of notification data;

FIG. 14 is a schematic diagram illustrating an example of another notification data;

FIG. 15 is a block diagram schematically illustrating a configuration of a first processing circuit according to another embodiment;

FIG. 16 is a diagram schematically illustrating configurations of a second storage device and a second processing circuit according to a still another embodiment; and

FIG. 17 is a block diagram schematically illustrating a configuration of a second processing circuit according to a still another embodiment.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

An image processing apparatus, an image processing system, an image processing method, and a program according to embodiments of the present disclosure are described below with reference to the drawings. The technical scope of the present disclosure, however, is not limited to the embodiments described below but includes the scope of the appended claims and the equivalents thereof.

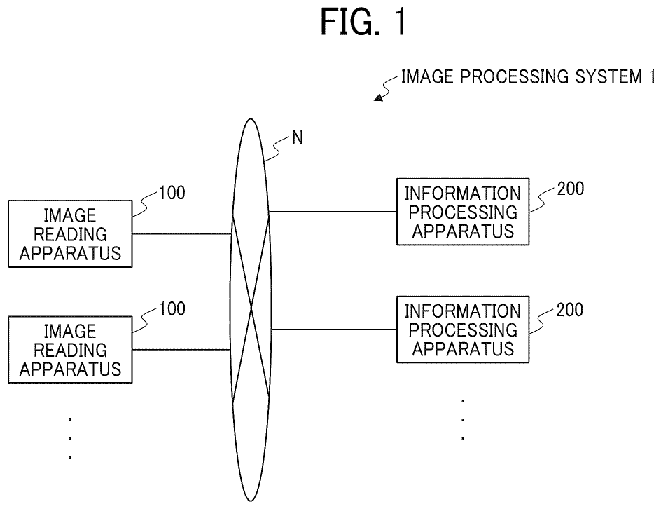

FIG. 1 is a diagram schematically illustrating a configuration of an image processing system 1 according to an embodiment.

As illustrated in FIG. 1, the image processing system 1 includes one or more image reading apparatuses 100 and one or more information processing apparatuses 200. The image reading apparatus 100 and the information processing apparatus 200 are communicably connected to each other through a network N. The network N is, for example, the Internet or an intranet. The image reading apparatus 100 and the information processing apparatus 200 are examples of an image processing apparatus.

The image reading apparatus 100 is, for example, an automatic document feeder (ADF) type scanner device that images a medium such as a document while conveying media. Examples of the medium include a sheet of plain paper, a sheet of thin paper, a sheet of thick paper, and a card. Examples of the medium further include various types of media such as a receipt, a business card, an invoice, and a delivery note. Alternatively, the image reading apparatus 100 may be, for example, a facsimile machine, a copier, or a multifunction peripheral (MFP).

The information processing apparatus 200 is, for example, a personal computer, a laptop personal computer, a tablet computer, or a smartphone. The information processing apparatus 200 may be a server provided in a cloud network.

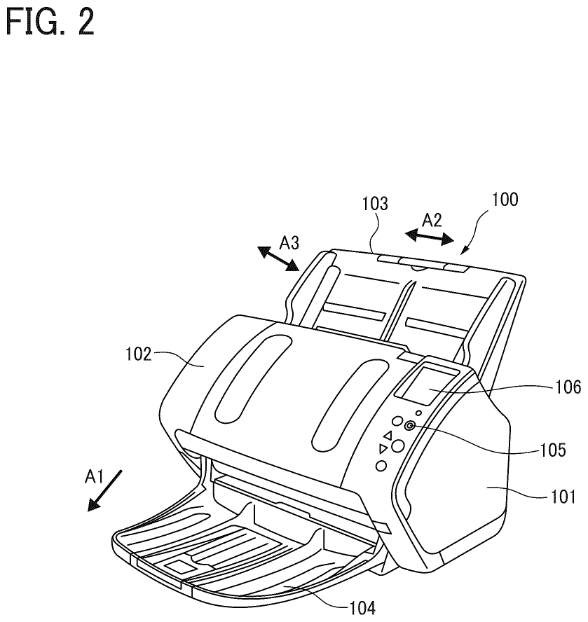

FIG. 2 is a perspective view of the image reading apparatus 100.

The image reading apparatus 100 includes, for example, a lower housing 101, an upper housing 102, a medium tray 103, an ejection tray 104, a first input device 105, and a first display device 106.

The upper housing 102 is disposed at a position covering the upper surface of the image reading apparatus 100, and is engaged with the lower housing 101 with a hinge such that the upper housing 102 can be opened and closed to, for example, remove a jammed medium or clean the inside of the image reading apparatus 100.

The medium tray 103 is engaged with the lower housing 101 such that the media to be conveyed can be placed on the medium tray 103. The ejection tray 104 is engaged with the lower housing 101 such that the media ejected from an ejection port can be placed on the ejection tray 104.

The first input device 105 includes an input device such as keys and an interface circuit that acquires signals from the input device. The first input device 105 receives an input operation performed by a user and outputs an operation signal corresponding to the input operation performed by the user. The first display device 106 includes a display and an interface circuit that outputs image data to the display and displays an image on the display according to the image data. Examples of the display include a liquid crystal display and an organic electro-luminescence (EL) display.

In FIG. 2, arrow A1 indicates the direction in which media are conveyed (may be referred to as a “media conveyance direction A1” in the following description). Arrow A2 indicates the width direction of the image reading apparatus 100 (may be referred to as a “width direction A2” in the following description) orthogonal to the media conveyance direction A1. Arrow A3 indicates the height direction orthogonal to the media conveyance direction A1 and the width direction A2. In the following description, the term “upstream” refers to upstream in the media conveyance direction A1, and the term “downstream” refers to downstream in the media conveyance direction A1.

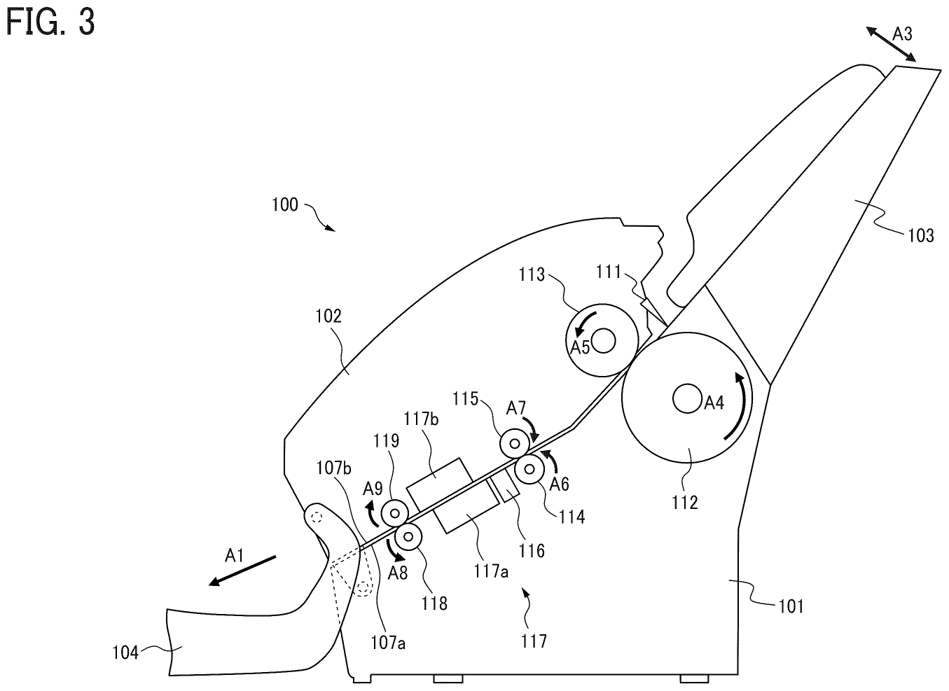

FIG. 3 is a diagram illustrating a conveyance passage inside the image reading apparatus 100.

The image reading apparatus 100 includes, along a conveyance passage, includes a first media sensor 111, a feed roller 112, a separation roller 113, a first conveyance roller 114, a second conveyance roller 115, a second media sensor 116, an imaging device 117, a third conveyance roller 118, and a fourth conveyance roller 119. The number of each of the above rollers is not limited to one, and may be two or more. When one or more of the above rollers are formed of multiple rollers, the multiple rollers are arranged at intervals in the width direction A2.

The image reading apparatus 100 includes a so-called straight path. The upper face of the lower housing 101 forms a lower guide 107a for the media conveyance passage. The lower face of the upper housing 102 forms an upper guide 107b for the media conveyance passage.

The first media sensor 111 is disposed upstream from the feed roller 112 and the separation roller 113. The first media sensor 111 includes a contact detection sensor and detects whether a medium is placed on the medium tray 103. The first media sensor 111 generates a first media signal of which the signal value changes depending on whether a medium is placed on the medium tray 103 and outputs the generated first media signal. The first media sensor 111 is not limited to a contact detection sensor. The first media sensor 111 may be any other sensor that can detect the presence of a medium. Examples of any other sensor include an optical detection sensor.

The feed roller 112 is disposed in the lower housing 101 and feeds the media from to the top from the medium tray 103. The separation roller 113 is a so-called brake roller or retard roller. The separation roller is disposed in the upper housing 102 and opposite to the feed roller 112.

The first conveyance roller 114 and the second conveyance roller 115 are disposed downstream from the feed roller 112 and the separation roller 113 and opposite to each other. The first conveyance roller 114 and the second conveyance roller 115 convey the media fed by the feed roller 112 and the separation roller 113 to the imaging device 117.

The second media sensor 116 is disposed downstream from the first conveyance roller 114 and the second conveyance roller 115 and upstream from the imaging device 117, and detects a medium conveyed to the position where the second media sensor 116 is disposed. The second media sensor 116 includes a light emitter, a light receiver, and a light guide tube. The light emitter and the light receiver are disposed on one side of the media conveyance passage (e.g., the lower housing 101 side). The light guide tube is disposed at a position opposite to the light emitter and the light receiver across the media conveyance passage (e.g., the upper housing 102 side). The light emitter is, for example, a light emitting diode (LED) and emits light toward the media conveyance passage. By contrast, the light receiver is, for example, a photodiode and receives light that is emitted by the light emitter and guided by the light guide tube. When the medium is present at a position opposite to the second media sensor 116, the light emitted from the light emitter is blocked by the medium, and therefore the light receiver does not detect the light emitted from the light emitter. Based on the intensity of the light received, the light receiver generates and outputs a second media signal of which the signal value changes between when a medium is present at the position of the second media sensor 116 and when a medium is absent at the position of the second media sensor 116.

A reflector such as a mirror may be used instead of the light guide tube. Further, the light emitter and the light receiver may be disposed opposite to each other across the media conveyance passage. Further, the second media sensor 116 may detect the presence of the medium with, for example, a contact sensor that causes a predetermined current to flow when a medium is in contact with the contact sensor or when no medium is in contact with the contact sensor.

The imaging device 117 is an example of an imaging unit. The imaging device 117 is disposed downstream from the first conveyance roller 114 and the second conveyance roller 115 and upstream from the third conveyance roller 118 and the fourth conveyance roller 119. The imaging device 117 includes a first imaging device 117a and a second imaging device 117b. The first imaging device 117a and the second imaging device 117b are disposed near the media conveyance passage and opposite to each other across the media conveyance passage.

The first imaging device 117a includes a light source and a contact image sensor (CIS) line sensor. The CIS line sensor employs an equal-magnification optical system and includes complementary metal oxide semiconductor (CMOS) imaging elements aligned linearly in the main-scanning direction. The first imaging device 117a further includes a lens and an analog-to-digital (A/D) converter. The lens forms an image on the imaging elements. The A/D converter amplifies the electrical signals output from the imaging elements and performs analog-to-digital (A/D) conversion. The first imaging device 117a obtains an input image by imaging the front side of each of the media sequentially conveyed by the conveying device, and outputs the input image.

In substantially the same manner, the second imaging device 117b includes a light source and a CIS line sensor. The CIS line sensor employs an equal-magnification optical system and includes CMOS imaging elements aligned linearly in the main-scanning direction. The second imaging device 117b further includes a lens and an A/D converter. The lens forms an image on the imaging elements. The A/D converter amplifies the electrical signals output from the imaging elements and performs analog-to-digital (A/D) conversion. The second imaging device 117b obtains an input image by imaging the back side of each of the media sequentially conveyed by the conveying device, and outputs the input image.

Alternatively, the image reading apparatus 100 may include either the first imaging device 117a or the second imaging device 117b to read only one side of the medium. The line sensor may be, instead of the CIS employing the equal-magnification optical system and including CMOSs as imaging elements, a CIS employing the equal-magnification optical system and including charge-coupled devices (CCDs) as imaging elements. Alternatively, a line sensor employing a reduction optical system and including a CMOS or CCD imaging element may be used.

The third conveyance roller 118 and the fourth conveyance roller 119 are disposed downstream from the imaging device 117 and opposite to each other. The third conveyance roller 118 and the fourth conveyance roller 119 eject the media conveyed by the first conveyance roller 114 and the second conveyance roller 115 onto the ejection tray 104.

As the feed roller 112 rotates in the direction of the arrow A4 in FIG. 3, the medium is conveyed from the medium tray 103 in the media conveyance direction A1 between the lower guide 107a and the upper guide 107b. The separation roller 113 rotates or stops in the direction of the arrow A5 in FIG. 3 when conveying the media. Due to the action of the feed roller 112 and separation roller 113, when a plurality of media is placed on the medium tray 103, only the medium in contact with the feed roller 112 among the media placed on the medium tray 103 is separated. This prevents the feeding of a medium other than the separated medium. In other words, the multiple feeding is prevented.

The medium is fed between the first conveyance roller 114 and the second conveyance roller 115 while being guided by the lower guide 107a and the upper guide 107b. As the first conveyance roller 114 rotates in the direction of the arrow A6 in FIG. 3 and the second conveyance roller 115 rotates in the direction of the arrow A7 in FIG. 3, the medium is fed between the first imaging device 117a and the second imaging device 117b. As the third conveyance roller 118 rotates in the direction of the arrow A8 in FIG. 3 and the fourth conveyance roller 119 rotates in the direction of the arrow A9 in FIG. 3, the medium read by the imaging device 117 is ejected to the ejection tray 104.

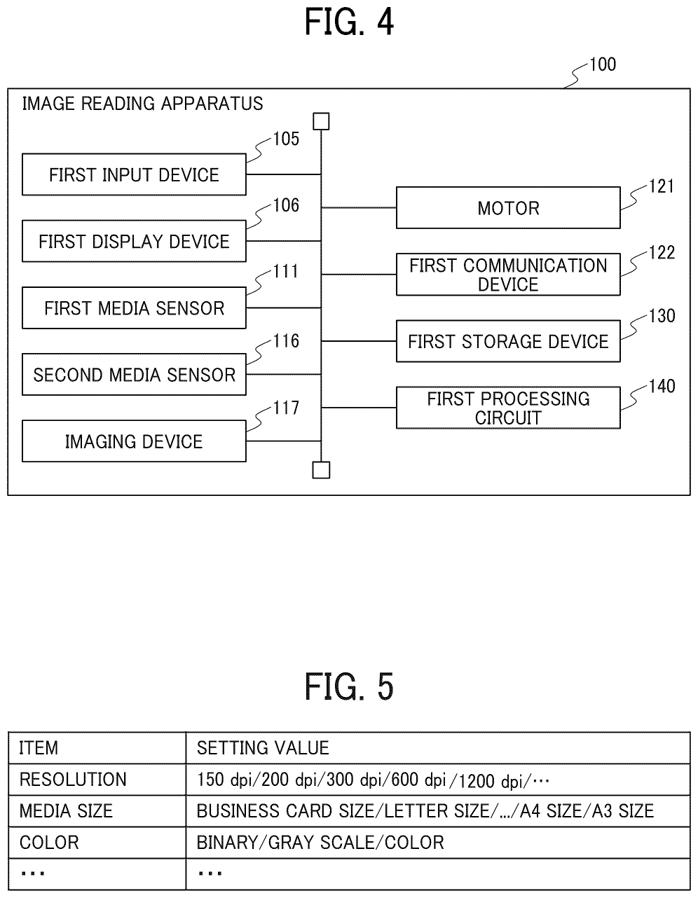

FIG. 4 is a block diagram schematically illustrating a configuration of the image reading apparatus 100.

In addition to the configuration described above, the image reading apparatus 100 includes a motor 121, a first communication device 122, a first storage device 130, and a first processing circuit 140.

The motor 121 includes one or a plurality of motors. The motor 121 rotates the feed roller 112, the separation roller 113, the first conveyance roller 114, the second conveyance roller 115, the third conveyance roller 118, and the fourth conveyance roller 119 according to a control signal from the first processing circuit 140 to perform the conveyance operation of the media. One of the first conveyance roller 114 and the second conveyance roller 115 may be a driven roller rotated by the rotation of the other roller. One of the third conveyance roller 118 and the fourth conveyance roller 119 may be a driven roller rotated by the rotation of the other roller.

The first communication device 122 includes an antenna and a wireless communication interface circuit. The antenna transmits and receives wireless signals. The wireless communication interface circuit transmits and receives signals through a wireless communication line according to a communication protocol such as a wireless local area network (LAN) protocol. The first communication device 122 communicates with the information processing apparatus 200. The first communication device 122 transmits and receives various images and information to and from the information processing apparatus 200 according to an instruction from the first processing circuit 140. The first communication device 122 may include a wired communication interface circuit according to a communication protocol such as the Transmission Control Protocol/Internet Protocol (TCP/IP), and may be connected to the information processing apparatus 200 through a network. The first communication device 122 may include an interface circuit compatible with a serial bus such as a universal serial bus (USB) and may be connected to the information processing apparatus 200 through a wired cable such as a USB cable.

The first storage device 130 includes memories such as a random-access memory (RAM) and a read-only memory (ROM); a fixed disk device such as a hard disk; or a portable memory such as a flexible disk or an optical disc. The first storage device 130 stores, for example, computer programs, databases, and tables used for various processes performed by the image reading apparatus 100. The computer programs may be installed in the first storage device 130 from a computer-readable portable recording medium using, for example, a known setup program. Examples of the portable recording medium includes a compact disc-read-only memory (CD-ROM) and a digital versatile disc-read-only memory (DVD-ROM). The computer program may be distributed from, for example, a server and installed in the first storage device 130.

Further, data such as a setting information table is prestored in the first storage device 130. The setting information includes a setting value for each of multiple setting items. The setting information may include a setting value on only a single setting item. A detailed description is given later of the setting information table.

The first processing circuit 140 operates according to a program prestored in the first storage device 130. The first processing circuit 140 is, for example, a central processing unit (CPU). Alternatively, as the first processing circuit 140, for example, a digital signal processor (DSP), a large scale integration (LSI), an application-specific integrated circuit (ASIC), or a field-programmable gate array (FPGA) may be used.

The first processing circuit 140 is connected to, for example, the first input device 105, the first display device 106, the first media sensor 111, the second media sensor 116, the imaging device 117, the motor 121, the first communication device 122, and the first storage device 130, and controls each of these components. The first processing circuit 140 controls, for example, the driving of the motor 121 and the imaging by the imaging device 117 to obtain an input image according to the setting value designated by for each of the setting items by the user via the first input device 105 or the first communication device 122. The first processing circuit 140 determines whether the setting value matches the characteristic of the input image for each of the setting items designated by the user. When the determination result indicates that the setting value does not match the characteristic of the input image, the first processing circuit 140 notifies the user of the determination result of or stops an image generation process.

FIG. 5 is a schematic diagram for describing a data structure of the setting information table.

As illustrated in FIG. 5, the setting information table stores one or more setting values of the setting items settable for each of the setting items regarding imaging processing or image processing specified by the setting information. The setting information is information regarding imaging processing or image processing in the image reading apparatus 100. The setting information specifies, for example, the operation of the image reading apparatus 100 for imaging a medium or image processing to be executed on the obtained image. In other words, the setting information is information on settings of a generating process for obtaining a desired input image, including at least one of imaging processing and image processing. For example, the setting information specifies the operation conditions of the image reading apparatus 100 for imaging a medium. Alternatively, the setting information specifies the content of image processing to be executed on the image obtained by the imaging. The setting items specified by the setting information include, for example, resolution, media size, and color.

Resolution, media size, and color are setting items relating to imaging processing. Further, resolution, media size, and color are also setting items relating to image processing.

The resolution is a setting of the resolution of an image to be generated. The setting value of the resolution is, for example, 150 dots per inch (dpi), 200 dpi, 300 dpi, 600 dpi, or 1200 dpi. The image reading apparatus 100 generates an image of which resolution is the resolution being set, by setting, for example, the media conveyance speed, the imaging timing (time interval) by the imaging device 117, and the position of the imaging element in the line sensor used for imaging in the imaging processing. Further, the image reading apparatus 100 generates an image of which resolution is the resolution being set, by executing, in the image processing, thinning or interpolation of the image generated in the imaging processing.

The media size is the setting of the size of the medium included in an image to be generated. Examples of the setting value of the media size include business card size, letter size, A4 size, A3 size, and automatic. When the automatic is set, the image reading apparatus 100 automatically detects the size of a medium included in the input image on the basis of the detection result of the medium by the second media sensor 116 or the input image generated by the imaging device 117. The image reading apparatus 100 generates an image including the medium of the detected size. The image reading apparatus 100 generates an image including a medium of the specified media size, by setting, for example, the timing at which the imaging device 117 finishes the imaging, and the position of the imaging element in the line sensor used for the imaging in the imaging processing. Further, the image reading apparatus 100 generates an image including a medium of the media size being set, by executing, in the image processing, cropping of the image generated in the imaging processing.

The color is the setting of the color of an image to be generated. Examples of the setting value of the color include binary, gray scale, color, and automatic. When the automatic is set, the image reading apparatus 100 automatically detects the color (binary, gray scale, or color) of the medium included in the input image on the basis of the input image generated by the imaging device 117 and generates an image according to the detected color. The image reading apparatus 100 changes the color of an image to be generated by setting, for example, the color of the light emitted by the light source of the imaging device 117 and the gradation range converted by the A/D converter in the imaging processing. Further, the image reading apparatus 100 changes the color of an image to be generated by, for example, executing, in the image processing, gray scale conversion or binarization of the color image generated in the imaging processing.

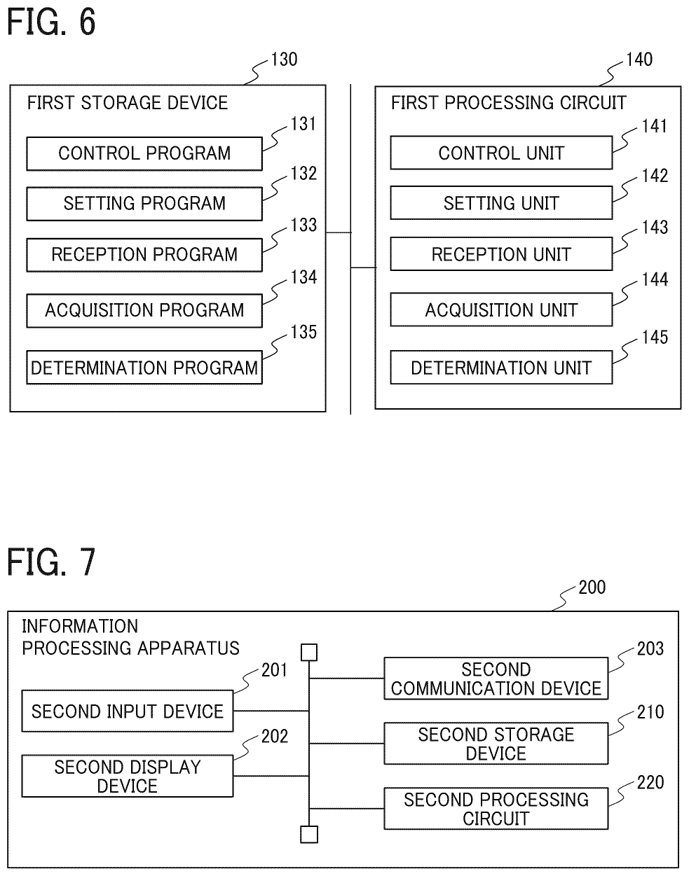

FIG. 6 is a diagram schematically illustrating configurations of the first storage device 130 and the first processing circuit 140.

As illustrated in FIG. 6, the first storage device 130 stores, for example, a control program 131, a setting program 132, a reception program 133, an acquisition program 134, and a determination program 135. These programs are functional modules implemented by software operating on a processor. The first processing circuit 140 reads the programs stored in the first storage device 130 and operates according to the read programs, thereby functioning as a control unit 141, a setting unit 142, a reception unit 143, an acquisition unit 144, and a determination unit 145.

FIG. 7 is a block diagram schematically illustrating a configuration of the information processing apparatus 200.

The information processing apparatus 200 includes a second input device 201, a second display device 202, a second communication device 203, a second storage device 210, and a second processing circuit 220.

The second input device 201 includes an input device such as a keyboard and a mouse, and an interface circuit that acquires signals from the input device. The second input device 201 outputs a signal corresponding to an operation by a user to the second processing circuit 220.

The second display device 202 includes a display including, for example, liquid crystal or organic EL, and an interface circuit that outputs image data to the display. The second display device 202 displays various types of information on the display according to an instruction from the second processing circuit 220.

The second communication device 203 includes an antenna that transmits and receives wireless signals, and a wireless communication interface circuit that transmits and receives signals through a wireless communication line according to a predetermined communication protocol such as a wireless LAN protocol. The second communication device 203 communicates with the image reading apparatus 100. The second communication device 203 transmits and receives various images and information to and from the image reading apparatus 100 according to an instruction from the second processing circuit 220. The second communication device 203 may include a wired communication interface circuit according to a communication protocol such as the TCP/IP, and may be connected to the image reading apparatus 100 through a network. The first communication device 122 may include an interface circuit compatible with a serial bus such as a USB and may be connected to the image reading apparatus 100 through a wired cable such as a USB cable.

The second storage device 210 includes memories such as a RAM and a ROM; a fixed disk device such as a hard disk; or a portable memory such as a flexible disk or an optical disc. The second storage device 210 stores, for example, computer programs, databases, and tables used for various processes performed by the information processing apparatus 200. The computer programs may be installed in the second storage device 210 from a computer-readable portable recording medium, such as a CD-ROM or a DVD-ROM, using, for example, a known setup program. Further, the computer programs may be distributed, for example, from a server and installed in the second storage device 210.

The second processing circuit 220 operates according to a program prestored in the second storage device 210. The second processing circuit 220 is, for example, a CPU. As the second processing circuit 220, for example, a DSP, a LSI, an ASIC, or a FPGA may be used.

The second processing circuit 220 is connected to, for example, the second input device 201, the second display device 202, the second communication device 203, and the second storage device 210, and controls each of these devices. The second processing circuit 220 performs, for example, control of transmitting and receiving data to and from the image reading apparatus 100 via the second communication device 203, input control of the second input device 201, and display control of the second display device 202.

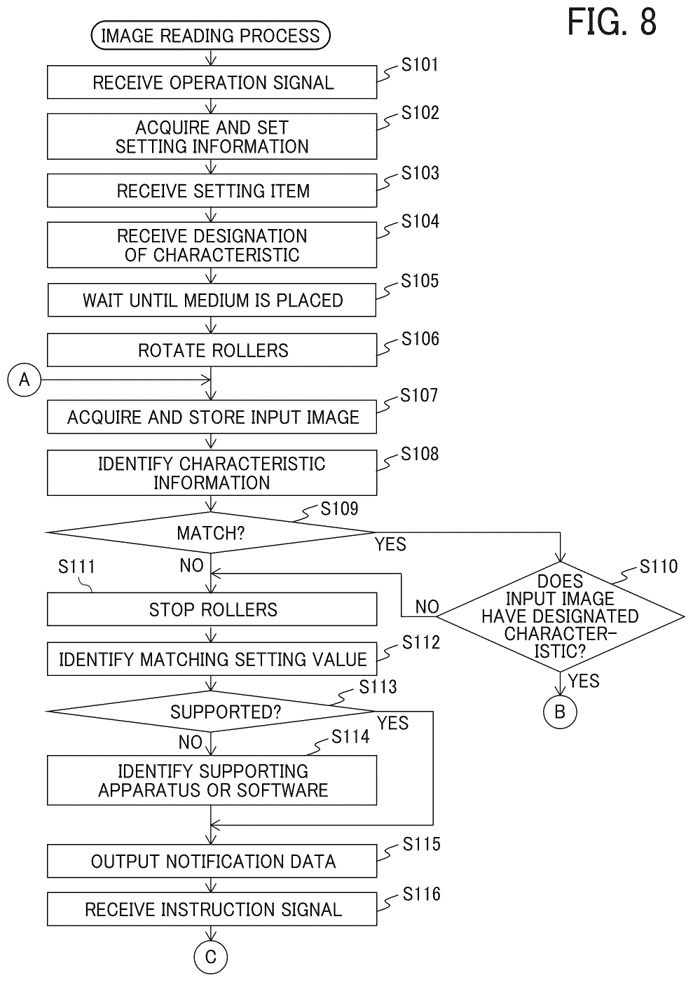

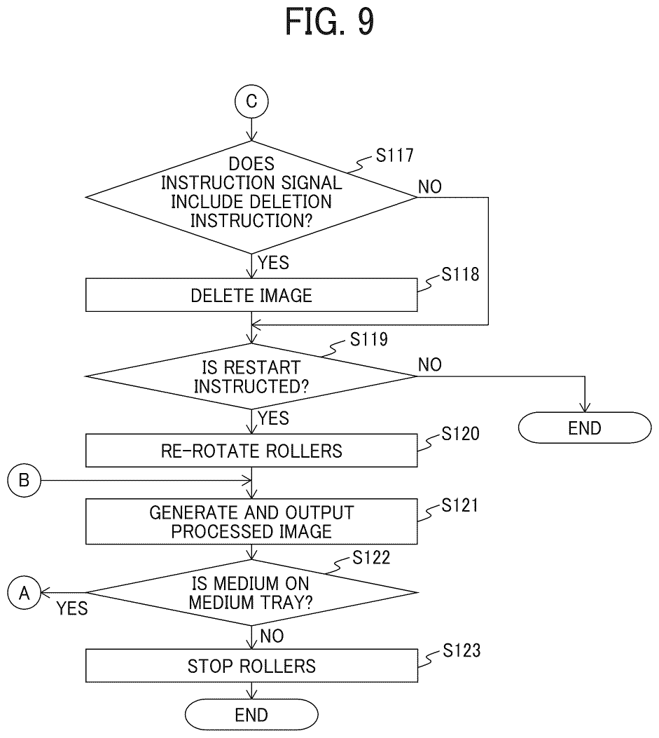

FIG. 8 is a flowchart of an example of an operation of an image reading process. FIG. 9 is a continuation of the flowchart of FIG. 8.

A description is given below of the image reading process performed by the image reading apparatus 100 with reference to the flowcharts of FIG. 8 of FIG. 9. The operation process described below is executed, for example, by the first processing circuit 140 in cooperation with the components of the image reading apparatus 100 according to the program prestored in the first storage device 130.

The control unit 141 waits until the control unit 141 receives an operation signal instructing the reading of media from the first input device 105 or the first communication device 122 (step S101). The operation signal is output when the user inputs an instruction to read media using the first input device 105 or the information processing apparatus 200. The operation signal includes setting information designated by the user using the first input device 105 or the information processing apparatus 200 along with the instruction to read media. The operation signal further includes one or more setting items on which determination is to be performed as to whether a setting value matches the characteristic of an input image obtained by imaging a medium. The one or more setting items are designated among the multiple setting items by the user using the first input device 105 or the information processing apparatus 200 along with the instruction to read media. In the following description, the determination as to whether the setting value matches the characteristic of the input image obtained by imaging the medium may be referred to as image determination.

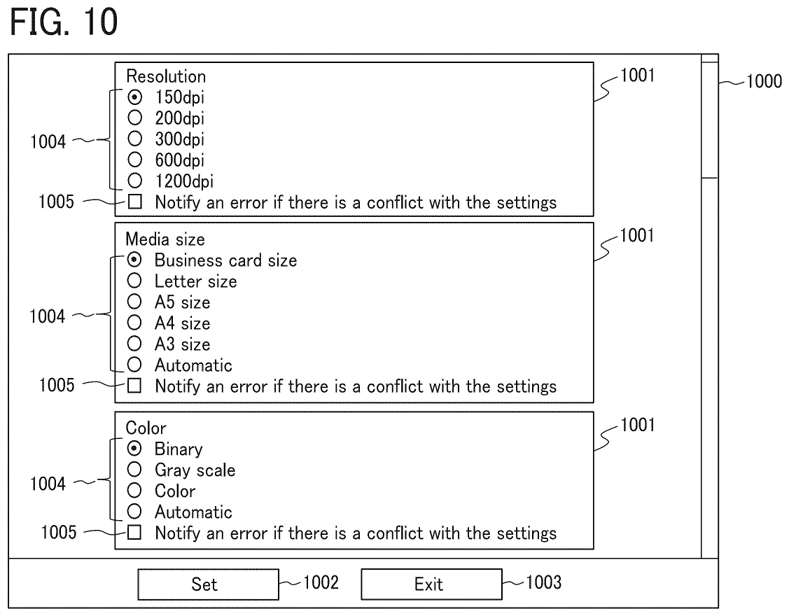

FIG. 10 is a schematic diagram illustrating an example of a reception screen 1000 that receives an operation by the user of designating the setting information and designating one or more setting items on which image determination is to be performed.

As illustrated in FIG. 10, the reception screen 1000 includes multiple setting objects 1001, a setting button 1002, and an exit button 1003. The setting objects 1001 are displayed respectively for the setting items specified by the setting information. Each of the setting objects 1001 includes a setting value designation button 1004 for designating a setting value of each setting item and a setting item designation button 1005 for designating whether to perform the image determination for each setting item. The user can designate a setting value for each of the setting items and can also designate whether the image determination is to be performed on the setting value. This makes it easy for the user to designate that the image determination is to be performed for a setting item for which an appropriate setting value is likely to be different between a medium to be processed and a medium that is likely to be included by mistake. On the reception screen 1000, for example, a box for designating one or more setting items on which the image determination is to be performed may be displayed instead of displaying, for each setting item, the button for designating whether the image determination is to be performed.

The setting button 1002 is a button for setting (confirming) the setting value designated in each of the setting objects 1001 and the setting item on which the image determination is to be performed. The exit button 1003 is a button for ending the display of the reception screen 1000.

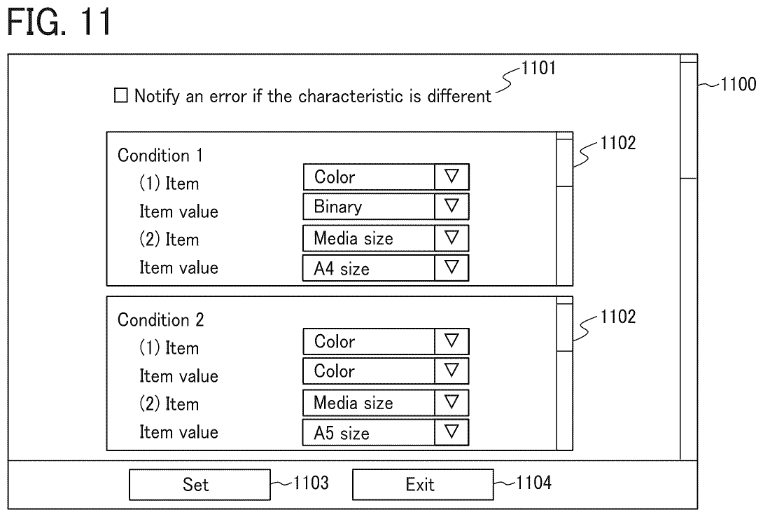

FIG. 11 is a schematic diagram illustrating an example of another reception screen 1100.

As illustrated in FIG. 11, the reception screen 1100 includes a notification designation button 1101, one or more condition setting objects 1102, a setting button 1103, and an exit button 1104. The notification designation button 1101 is a button for designating whether to notify the user when none of conditions designated in any condition setting object 1102 among the one or more condition setting objects 1102 is satisfied.

Each of the condition setting objects 1102 is an object for setting a combination of setting values of one or more setting items that matches the characteristic of a medium to be imaged, i.e., the characteristic of an image obtained by imaging the medium. The combination that is designated in each of the condition setting objects 1102 and that matches the characteristic of the image obtained by imaging the medium is a condition of a combination of the setting values of the setting items that is allowed for the medium to be imaged. For example, when “automatic” is set for a particular setting item, the user can designate an allowable setting value for the setting item. When the condition designated by any of the condition setting objects 1102 is not satisfied, the image reading apparatus 100 notifies the user of a warning. When a bundle of media including multiple types of media, such as a bundle of media including only a A4 size form and a A5 size form or a bundle of media including only a A4 size form and a photograph, is processed collectively, the user can check that such a bundle of media does not include other types of media.

The user may designate only one condition setting object 1102 among the condition setting objects 1102. In other words, the number of combinations of setting values of the setting items designated by the user may be only one. Further, the user may designate the setting values of setting items that are different from each other in the condition setting objects 1102. In other words, the types of the setting items for which the allowable setting values are designated by the user may be different for each combination. Furthermore, the user may designate a setting value for only a single setting item in each of the condition setting objects 1102. In other words, the number of setting items for which the user designates an allowable setting value may be only one.

The setting button 1103 is a button for setting (confirming) the item designated in the notification designation button 1101 and the combination designated in each of the condition setting objects 1102. The exit button 1104 is a button for ending the display of the reception screen 1100.

The operation signal may further include the characteristic of a medium to be imaged, i.e., the characteristic of an image obtained by imaging the medium. The characteristic is designated along with the instruction to read media by the user using the first input device 105 or the information processing apparatus 200.

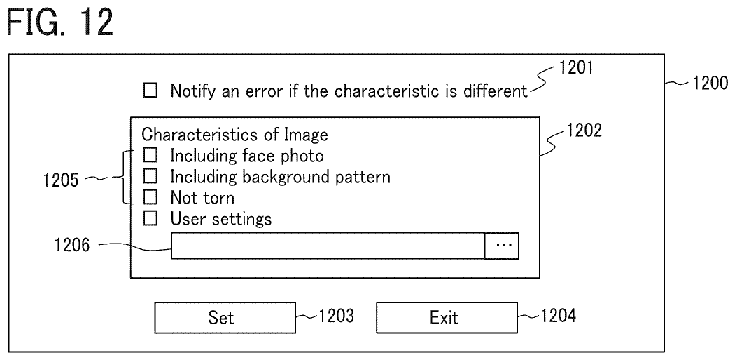

FIG. 12 is a schematic diagram illustrating an example of a reception screen 1200 that receives an operation by the user of designating the characteristic of the image.

As illustrated in FIG. 12, the reception screen 1200 includes a notification designation button 1201, a characteristic setting object 1202, a setting button 1203, and an exit button 1204. The notification designation button 1201 is a button for designating whether to notify the user when the input image obtained by imaging a medium does not have a characteristic designated in the characteristic setting object 1202.

The characteristic setting object 1202 includes a characteristic designation button 1205 and a characteristic designation box 1206, which are for designating the characteristic of the medium to be imaged, i.e., the characteristic of the image obtained by imaging the medium. The characteristic designation button 1205 is a button for selecting a characteristic of the image from among multiple characteristics that are defined in advance in the image reading apparatus 100. Examples of the characteristics of the image include the presence of a face photograph, the presence of a ground pattern, and the presence of damage. The characteristic designation box 1206 is a box for designating a characteristic of the image that is not defined in advance in the image reading apparatus 100. The user enters, for example, text having a predetermined format (e.g., the position of a face photograph or damage in a medium, a background in a medium, or a color of characters) or an image having such a characteristic (or a path to an address where the image is stored) into the characteristic designation box 1206. The user may enter a program module (or a path to an address where the image is stored) for determining whether an image that is input includes a particular characteristic in the characteristic designation box 1206. The program module is created so as to output a determination result indicating whether an image includes the particular characteristic when the image is input. Thus, the image reading apparatus 100 can enhance the degree of freedom in designating a characteristic of the image obtained by imaging the medium.

The setting button 1203 is a button for setting (confirming) the item designated in the notification designation button 1201 and the characteristic designated in the characteristic setting object 1202. The exit button 1104 is a button for ending the display of the reception screen 1200.

Subsequently, the setting unit 142 acquires the setting information included in the operation signal, sets the acquired setting information in the first storage device 130, and configures the settings of, for example, the imaging device 117 and the motor 121 to generate an input image corresponding to the acquired setting information (step S102).

The setting unit 142 acquires the setting value designated by the user for each of the setting items using, for example, the setting value designation buttons 1004 illustrated in FIG. 10. The setting unit 142 configures the settings of, for example, the imaging device 117 and the motor 121 to generate an input image according to the acquired setting value for each of the setting item. The setting unit 142 configures the settings of, for example, the imaging device 117 and the motor 121 to generate an input image whose quality is equal to or higher the image quality according to the setting value for each of the setting items. For example, the setting unit 142 configure settings of, for example, the imaging device 117 and the motor 121 to generate the input image of which the resolution is the maximum resolution supported by the image reading apparatus 100, the media size is the maximum media size supported by the image reading apparatus 100, and the color is color. As a result, the image reading apparatus 100 can appropriately determine whether the set setting information matches the characteristic of the input image based on the input image and generate an image according to the setting information designated by the user in the processing described below.

The setting unit 142 may acquire multiple setting values designated by the user for a particular setting item using the condition setting objects 1102 illustrated in FIG. 11 and set the setting values in the image reading apparatus 100. In that case, the setting unit 142 configures the settings of, for example, the imaging device 117 and the motor 121 to generate the input image having a quality equal to or higher than the quality of each image according to each of the designated setting values. For example, the setting unit 142 configure settings of, for example, the imaging device 117 and the motor 121 to generate the input image of which the resolution is the maximum resolution supported by the image reading apparatus 100, the media size is the maximum media size supported by the image reading apparatus 100, and the color is color. Thus, the image reading apparatus 100 can generate an image according to the setting value corresponding to the characteristic of the input image among the setting values designated by the user from the input image in the processing described below.

The setting unit 142 may acquire multiple sets each of which includes setting values for a predetermined number of setting items using the condition setting objects 1102 illustrated in FIG. 11 and set the acquired sets in the image reading apparatus 100. In that case also, the setting unit 142 configures the settings of, for example, the imaging device 117 and the motor 121 to generate the input image having a quality equal to or higher than the quality of each image according to each of the designated setting values.

The setting information may be designated by the user before inputting the instruction to read medium and stored in the first storage device 130, instead of being designated along with the instruction to read the medium. In that case, the setting unit 142 acquires the setting information by reading the setting information from the first storage device 130. Further, the control unit 141 sets (initializes) the media number of the medium to be conveyed to 1.

Subsequently, the reception unit 143 acquires the setting item on which the image determination is to be performed included in the operation signal, and stores the setting item in the first storage device 130 (step S103). Thus, the reception unit 143 receives the user's designation of a setting item on which determination is to be performed as to whether the setting value matches the characteristic of the input image obtained by imaging the medium among the setting items.

The reception unit 143 receives the designation of whether the image determination is to be performed for each of the setting items, using, for example, the setting item designation buttons 1005 illustrated in FIG. 10. In this case, the user can designate, for each of the setting items, whether the image determination is to be performed on the designated setting value. Accordingly, the user can appropriately select the setting item on which the image determination is to be performed. Thus, the image reading apparatus 100 can enhance user convenience.

The reception unit 143 may receive designation of a setting item on which the image determination is to be performed, using the condition setting objects 1102 illustrated in FIG. 11. In this case, when multiple types of media are included in a bundle of media to be imaged, the user can appropriately select the setting item on which the image determination is to be performed. Thus, the image reading apparatus 100 can enhance user convenience.

The setting item on which the image determination is to be performed may be designated by the user before the reading instruction is input and stored in the first storage device 130, instead of being designated along with the reading instruction. In this case, the setting unit 142 acquires the setting item on which the image determination is to be performed by reading the setting item from the first storage device 130.

Subsequently, the reception unit 143 acquires the characteristic of an image that is designated by the user and is included in the operation signal, and stores the acquired characteristic in the first storage device 130 (step S104). Thus, the reception unit 143 receives the user's designation of the characteristic of the image.

The reception unit 143 receives the characteristic of the image selected by the user from the characteristics defined in advance in the image reading apparatus 100 using, for example, the characteristic designation button 1205 illustrated in FIG. 12. The reception unit 143 may receive the characteristic of the image selected by the user from the characteristics that are not defined in advance in the image reading apparatus 100 using, for example, the characteristic designation box 1206 illustrated in FIG. 12. By using the characteristic designation box 1206, the image reading apparatus 100 can enhance the degree of freedom in designating the characteristic of the image obtained by imaging the medium.

The characteristic of the image may be designated by the user before inputting the instruction to read medium and stored in the first storage device 130, instead of being designated along with the instruction to read the medium. In this case, the setting unit 142 acquires the characteristic of the image designated by the user by reading the designated characteristic from the first storage device 130.

Subsequently, the control unit 141 waits until the media are placed on the medium tray 103 (step S105). The control unit 141 acquires a first media signal from the first media sensor 111 and determines whether media are placed on the medium tray 103 on the basis of the acquired first media signal.

Subsequently, the control unit 141 drives the motor 121 to rotate the feed roller 112, the separation roller 113, the first conveyance roller 114, the second conveyance roller 115, the third conveyance roller 118, and/or the fourth conveyance roller 119 (step S106). Thus, the control unit 141 feeds and conveys the media from the medium tray 103. The control unit 141 controls the motor 121 so that an input image according to the setting information acquired in step S102 is generated. The control unit 141 controls the motor 121 in particular to rotate at a speed that implements generation of an image with the resolution specified by the setting information.

Subsequently, the acquisition unit 144 acquires the input image obtained by imaging the conveyed medium from the imaging device 117, and stores the input image in the first storage device 130 in association with the media number (step S107).

For example, the acquisition unit 144 determines whether the leading end of the medium has passed the position of the second media sensor 116 on the basis of the second media signal received from the second media sensor 116. The acquisition unit 144 acquires the second media signal periodically from the second media sensor 116 and determines that the leading end of the medium has passed the position of the second media sensor 116 when the signal value of the second media signal changes from a value indicating the absence of a medium to a value indicating the presence of a medium. The acquisition unit 144 controls the imaging device 117 to start imaging when the leading end of the medium has passed the position of the second media sensor 116. The control unit 141 controls the imaging device 117 to generate the input image according to the setting information acquired in step S102.

Thereafter, the acquisition unit 144 controls the imaging device 117 to finish imaging when the medium has been conveyed by the amount obtained by adding a margin to the media size indicated by the setting information acquired in step S102. The acquisition unit 144 may control the imaging device 117 to finish imaging when the trailing end of the medium has passed through the imaging position of the imaging device 117. For example, the acquisition unit 144 determines whether the trailing end of the medium has passed the position of the second media sensor 116 on the basis of the second media signal received from the second media sensor 116. The acquisition unit 144 acquires the second media signal periodically from the second media sensor 116 and determines that the leading end of the medium has passed the position of the second media sensor 116 when the signal value of the second media signal changes from a value indicating the presence of a medium to a value indicating the absence of a medium. The acquisition unit 144 determines that the trailing end of the medium has passed the imaging position in the imaging device 117 when a first predetermined time period has elapsed after the trailing end of the medium passes the position of the second media sensor 116. The first predetermined time period is set to a time taken for a medium to move from the second media sensor 116 to the imaging position.

The acquisition unit 144 acquires the input image from the imaging device 117 every time the imaging device 117 generates predetermined lines of the input image and synthesizes the acquired input images when the imaging device 117 finishes imaging. The control unit 141 may collectively acquire input images for all lines at a time when the imaging device 117 finishes the imaging.

Subsequently, the determination unit 145 identifies, for each of the setting items designated by the user, characteristic information corresponding to each of the setting item in the input image (step S108).

The characteristic information indicates a characteristic of an input image regarding the imaging processing or the image processing, in particular, a characteristic of a medium included in the input image. The characteristic information includes items that respectively relate to one or more setting items specified by the setting information. Items specified by the characteristic information include the presence of a photograph, size, and color component.

The item “presence of a photograph” indicates whether the input image includes a photograph and corresponds to, for example, the resolution or color among the setting items specified by the setting information. For example, the determination unit 145 determines whether a photograph is included in the input image using a discriminator trained in advance to output whether a photograph is included in an image when the image is input. The discriminator is trained in advance by, for example, deep learning using images including various photographs and is stored in the first storage device 130 in advance. The determination unit 145 inputs the input image to the discriminator and determines whether a photograph is included in the input image on the basis of information output from the discriminator.

The determination unit 145 may estimate whether a photograph is included in the input image on the basis of the spatial frequencies of the input image. In this case, the determination unit 145 performs frequency conversion such as Fourier transform on the input image and identifies the distribution of spatial frequency distribution in the input image. When the maximum value of the spatial frequencies in the input image is equal to or greater than a predetermined frequency threshold value, the determination unit 145 determines that a photograph is included in the input image. When the maximum value of the spatial frequencies in the input image is smaller than the predetermined frequency threshold value, the determination unit 145 determines that the input image does not include a photograph. Alternatively or additionally, the determination unit 145 may estimate whether the input image includes a photograph on the basis of the distribution of gradation values such as brightness values or color values of pixels in the input image. In this case, the determination unit 145 calculates the variance of the gradation values of the pixels in the input image. When the calculated variance is equal to or greater than a predetermined variance threshold value, the determination unit 145 determines that a photograph is included in the input image. When the calculated variance is smaller than the predetermined variance threshold value, the determination unit 145 determines that the input image does not include a photograph.

The item “size” indicates the size of a medium included in the input image and corresponds to, for example, the media size among the setting items specified by the setting information. For example, the determination unit 145 extracts edge pixels of which gradation values such as brightness values or color values differ from the gradation values of the adjacent pixel by equal to or greater than a predetermined threshold value in the input image. The determination unit 145 detects the largest area among areas surrounded by the edge pixels adjacent to each other as a medium area. The determination unit 145 identifies the size of the medium included in the input image on the basis of the number of pixels of the detected medium area and the resolution being set when the input image is generated.

The item “color component” indicates the color components (color or black and white) included in the input image and corresponds to, for example, the color among the setting items specified by the setting information. For example, the determination unit 145 determines whether the color component included in the input image is color or black and white on the basis of the distribution of the color values such as the R value, G value, or B value of the pixels in the input image. The determination unit 145 calculates the variances of the color values of the pixels in the input image. When the average value of the calculated variances is equal to or greater than a predetermined variance threshold value, the determination unit 145 determines that the component of the color included in the input image is color. When the average value of the calculated variances is smaller than the predetermined variance threshold value, the determination unit 145 determines that the component of the color included in the input image is black and white.

Subsequently, the determination unit 145 determines, for each of the setting items designated by the user, whether the setting value specified by the user matches the characteristic of the input image, i.e., the characteristic information corresponding to each of the setting items in the input image (step S109).

Regarding the resolution, when it is identified as the characteristic information that a photograph is included in the input image, the determination unit 145 determines that the setting value matches the characteristic information when the setting value is equal to or greater than a resolution threshold value, and determines that the setting value does not match the characteristic information when the setting value is smaller than the resolution threshold value. The resolution threshold value is set to a value (e.g., 200 dpi), which is a value between a resolution at which an image including a photograph is displayed suitable for viewing and a resolution at which an image including a photograph is displayed unsuitable for viewing. The resolution threshold value may be set to any desired value (e.g., 300 dpi). By contrast, when it is identified as the characteristic information that the input image does not include a photograph, the determination unit 145 determines that the setting value matches the characteristic information when the setting value is smaller than the resolution threshold value, and determines that the setting value does not match the characteristic information when the setting value is equal to or greater than the resolution threshold value.

Regarding the media size, the determination unit 145 determines that setting value matches the characteristic information when a difference between the size identified as the characteristic information and the setting value is equal to or smaller than a size threshold value, and determines that the setting value does not match the characteristic information when the difference is greater than the size threshold value. The size threshold value is set in advance to any desired value (e.g., the difference between A3 size and A4 size). The size threshold value may be set to zero. In other words, the determination unit 145 may determine that the setting value matches the characteristic information when the size identified as the characteristic information and the setting value match each other, and may determine that the setting value does not match the characteristic information when the size identified as the characteristic information and the setting value do not match each other.

Regarding the color, when it is identified as the characteristic information that a photograph is included in the input image as the characteristic information, the determination unit 145 determines that the setting value matches the characteristic information when the setting value is color, and determines that the setting value does not match the characteristic information when the setting value is gray scale or binary. By contrast, when it is identified as the characteristic information that a photograph is not included in the input image, the determination unit 145 determines that the setting value matches the characteristic information when the setting value is gray scale or binary, and determines that the setting value does not match the characteristic information when the setting value is color.

Further, regarding the color, when the color component is identified as color as the characteristic information, the determination unit 145 determines that setting value matches the characteristic information when the setting value is color, and determines that the setting value does not match the characteristic information when the setting value is gray scale or binary. By contrast, when the color component is identified as black and white as the characteristic information, the determination unit 145 determines that the setting value matches the characteristic information the setting value is gray scale or binary, and determines that the setting value does not match the characteristic information when the setting value is color.

When the determination unit 145 determines that the setting value does not match the characteristic information in any one setting item of the setting items designated by the user, the determination unit 145 determines that the setting value designated by the user does not match the characteristic of the input image. By contrast, when the determination unit 145 determines that the setting values match the characteristic information in all setting items of the setting items designated by the user, the determination unit 145 determines that the setting value designated by the user matches the characteristic of the input image.

When a setting item to which multiple setting values are set is designated as a setting item on which the image determination is to be performed, the determination unit 145 determines that the setting value does not match the characteristic of the input image when the determination unit 145 determines that none of the multiple setting values matches the characteristic of the input image for the setting item. By contrast, in this case, when the determination unit 145 determines that any of the multiple setting values matches the characteristic of the input image for the setting item, the determination unit 145 determines that the setting value matches the characteristic of the input image.

In a case where multiple sets each of which includes setting values for the predetermined number of setting items are set as the setting items on which the image determination is to be performed, the determination unit 145 determines that the setting value does not match the characteristic of the input image when the determination unit 145 determines that any of the setting values for the predetermined number of setting items does not match the characteristic of the input image in any of the multiple sets. By contrast, in this case, when the determination unit 145 determines that all of the setting values of the predetermined number of setting items in any of the multiple sets match the characteristics of the input image, the determination unit 145 determines that the setting values match the characteristics of the input image.

Also when the setting value is “automatic,” the determination unit 145 may determine that the setting value does not match the characteristic of the input image when the characteristic information satisfies a predetermined condition such as when the size is a business card size or when the color component is binary.

When the determination unit 145 determines that the setting information matches the characteristic of the input image, the determination unit 145 further determines whether the input image has the characteristic designated by the user (step S110).

When the designated characteristic of the image is the presence of an object such as a face photograph, a ground pattern, or damage, or the position of the object in the medium, the determination unit 145 determines whether the object is included in the image and identified the position of the object using, for example, a discriminator. This discriminator is trained in advance to output, in response to the input of an image, whether the image includes the object and the position of the object in a medium. The discriminator is trained in advance by, for example, deep learning using images including various objects in various positions and is stored in the first storage device 130 in advance. The determination unit 145 inputs the input image to the discriminator to determine whether the input image includes the object and specify the position of the object in the medium on the basis of information output from the discriminator. The determination unit 145 determines whether the input image has the characteristic designated by the user on the basis of the determination result of whether the input image includes the object or whether the position of the object matches the characteristic designated by the user.

When the designated characteristic of the image is a color of a background in a medium, the determination unit 145 detects a medium area, for example, in the same or substantially the same manner in the case of identifying the characteristic information. The determination unit 145 determines which of multiple predetermined color ranges (e.g., a white color range, a black color range, a red color range, a green color range, and a blue color range) the color values (e.g., an R value, a G value, an a B value) of the pixels in the medium area belong to respectively. The determination unit 145 identifies a color corresponding to a particular color range having the largest number of pixels to which the color values belong as the color of the background in the medium. The determination unit 145 determines whether the input image has the characteristic designated by the user on the basis of whether the identified color matches the color designated by the user.

When the designated characteristic of the image is a color of a character in a medium, the determination unit 145 detects a medium area, for example, in the same or substantially the same manner in the case of identifying the characteristic information. The determination unit 145 performs optical character recognition (OCR) processing on the medium area and identifies a character area in which a character is detected in the input image. The determination unit 145 determines which of multiple predetermined color ranges (e.g., a white color range, a black color range, a red color range, a green color range, and a blue color range) the color values (e.g., an R value, a G value, an a B value) of the pixels in the character area belong to respectively. The determination unit 145 identifies a color corresponding to a particular color range having the largest number of pixels to which the color values belong as the color of character in the medium, except for the color range identified as the color of the background. The determination unit 145 determines whether the input image has the characteristic designated by the user on the basis of whether the identified color matches the color designated by the user.

Further, when an image having a characteristic of the image obtained by imaging the medium is designated in the characteristic designation box 1206 illustrated in FIG. 12, the determination unit 145 determines whether the input image has the characteristic designated by the user on the basis a degree of similarity between the designated image and the input image. The degree of similarity is, for example, a normalized cross-correlation value. The determination unit 145 calculates the degree of similarity between the designated image and the input image, and determines whether the input image has the characteristic designated by the user on the basis of whether the calculated degree of similarity is equal to or greater than a predetermined degree-of-similarity threshold value.

When a program module is designated in the characteristic designation box 1206, the determination unit 145 determines whether the input image has the characteristic designated by the user using the program module. The determination unit 145 inputs the input image to the program module and determines whether the input image has the characteristic designated by the user on the basis of the determination result output from the program module.

When the determination unit 145 determines that the input image has the characteristic designated by the user, the operation proceeds to step S119.

By contrast, when the determination unit 145 determines in step S109 that the setting information does not match the characteristic of the input image or determines in step S110 that the input image does not have the characteristic designated by the user, the control unit 141 controls the motor 121 to stop. Accordingly, the control unit 141 controls the feed roller 112, the separation roller 113, the first conveyance roller 114, the second conveyance roller 115, the third conveyance roller 118, and/or the fourth conveyance roller 119 to stop rotating, and suspends conveying subsequent media (step S111).

Thus, when the determination unit 145 determines that the setting value designated by the user does not match the characteristic of the input image, the control unit 141 controls the image reading apparatus 100 that has generated the input image to stop the image generation process. When the setting value does not match the imaged medium, the image reading apparatus 100 suspends conveying subsequent media, allowing the user to take measures such as taking out the medium at that timing. Thus, the image reading apparatus 100 can enhance user convenience.

When a setting item to which multiple setting values are set is designated by the user as a setting item on which the image determination is to be performed, the control unit 141 controls the apparatus that has generated the input image to stop the image generation process when the determination unit 145 determines that none of the multiple setting values matches the characteristic of the input image. Accordingly, for example, when an unexpected medium is included in a bundle of media including multiple types of media, the user can take measures such as taking out such an unexpected medium at that timing. Thus, the image reading apparatus 100 can enhance user convenience.

When a predetermined number of setting items included in multiple sets each of which includes a setting value for each of the predetermined number of setting items are designated as setting items on which the image determination is to be performed, the control unit 141 controls the apparatus that has generated the input image to stop the image generation process when the determination unit 145 determines that the setting value for each of the predetermined number of setting items does not match the characteristic of the input image in any of the multiple sets. Accordingly, for example, when an unexpected medium is included in a bundle of media including multiple types of media, the user can take measures such as taking out such an unexpected medium at that timing. Thus, the image reading apparatus 100 can enhance user convenience.

When the determination unit 145 determines that the input image does not have the characteristic designated by the user, the control unit 141 controls the apparatus that has generated the input image to stop the image generation process. Accordingly, for example, when an unexpected medium is included in media to be processed, the user can take measures such as taking out such an unexpected medium at that timing. Thus, the image reading apparatus 100 can enhance user convenience.

Subsequently, the control unit 141 identifies a setting value that matches the characteristic of the input image for each of the setting items that are determined not to match the characteristic of the input image and stores the identified setting value in the first storage device 130 in association with the media number (step S112). The control unit 141 identifies, a setting value that matches the characteristic information for each setting item for which it is determined in step S108 that the setting value designated by the user does not match the characteristic of the input image, that is, the characteristic information corresponding to the setting item of the input image.

When the determination unit 145 determines that the setting value of the resolution does not match the characteristic information, the control unit 141 identifies the minimum setting value of the setting values equal to or greater than the resolution threshold value as the setting value matching the characteristic information when it is identified that the input image includes a photograph as the characteristic information. In this case, the control unit 141 may identify the maximum of the setting values as the setting value matching the characteristic information. By contrast, when the determination unit 145 identifies that the input image includes no photograph as the characteristic information, the control unit 141 identifies the maximum setting value of the setting values smaller than the resolution threshold value as the setting value matching the characteristic information. In this case, the control unit 141 may identify the minimum of the setting values as the setting value matching the characteristic information.

When the determination unit 145 determines that the setting value of the media size does not match the characteristic information, the control unit 141 identifies the size identified as the characteristic information as the setting value matching the characteristic information.

When the determination unit 145 determines that the setting value of the color does not match the characteristic information, the control unit 141 identifies color as the setting value matching the characteristic information when it is identified that the input image includes a photograph as the characteristic information. By contrast, when it is identified that the input image includes no photograph as the characteristic information, the control unit 141 identifies gray scale or binary as the setting value matching the characteristic information. Alternatively, when the color components are identified as color as the characteristic information, the control unit 141 may identify color as the setting value matching the characteristic information. In this case, when the color components are identified as black and white as the characteristic information, the control unit 141 identifies gray scale or binary as the setting value matching the characteristic information.

In this way, when it is determined that the setting value does not match the characteristic of the input image, the control unit 141 identifies the setting information matching the characteristic of the input image.

Subsequently, the control unit 141 determines whether the setting value identified as the setting value matching the characteristic of the input image is supported by the image reading apparatus 100 (step S113). When the identified setting value is supported by the image reading apparatus 100, the control unit 141 does not perform any particular process, and the operation proceeds to step S115.

By contrast, when the identified setting value is not supported by the image reading apparatus 100, the control unit 141 identifies another image reading apparatus or another software that supports the identified setting value (step S114). Such another image reading apparatus is an image reading apparatus other than the image reading apparatus 100 and is included in the image processing system 1. Such another software is software other than the software installed in the image reading apparatus 100 and is included in the image processing system 1. The software is, for example, driver software that causes the image reading apparatus 100 to execute each process.

Subsequently, the control unit 141 generates notification data for notifying the user that the setting value designated by the user does not match the characteristic of the input image or that the input image does not have the characteristic designated by the user. The control unit 141 notifies the user by outputting the notification data by displaying the generated notification data on the first display device 106 or by transmitting the generated notification data to the information processing apparatus 200 via the first communication device 122 (step S115). In response to receiving the notification data from the image reading apparatus 100 via the second communication device 203, the information processing apparatus 200 displays the received notification data on the second display device 202. The notification data is an example of information regarding a determination result by the determination unit 145.

In this way, when the determination unit 145 determines that the setting value designated by the user does not match the characteristic of the input image, the control unit 141 notifies the user of the information regarding the determination result. When the setting value does not match the characteristic of the imaged medium, the image reading apparatus 100 notifies the user that the setting value does not match the characteristic of the imaged medium. Accordingly, the user can have the image reading apparatus 100 to restart the conveying and imaging of the medium according to appropriate settings. Thus, the image reading apparatus 100 can enhance user convenience.

When a setting item to which multiple setting values are set is designated by the user as a setting item on which the image determination is to be performed, the control unit 141 notifies the user of the information regarding the determination result when the determination unit 145 determines that none of the multiple setting values matches the characteristic of the input image. Accordingly, for example, when an unexpected medium is included in a bundle of media including multiple types of media, the user can have the image reading apparatus 100 to restart the conveying and imaging of the medium according to appropriate settings. Thus, the image reading apparatus 100 can enhance user convenience.

When a predetermined number of setting items included in multiple sets each of which includes a setting value for each of the predetermined number of setting items are designated as setting items on which the image determination is to be performed, the control unit 141 notifies the user of the information regarding the determination result when the determination unit 145 determines that the setting value for each of the predetermined number of setting items does not match the characteristic of the input image in any of the multiple sets. Accordingly, for example, when an unexpected medium is included in a bundle of media including multiple types of media, the user can have the image reading apparatus 100 to restart the conveying and imaging of the medium according to appropriate settings. Thus, the image reading apparatus 100 can enhance user convenience.

Further, when the determination unit 145 determines that the input image does not have the characteristic designated by the user, the control unit 141 notifies the user of the information regarding the determination result. Accordingly, for example, when an unexpected medium is included in media to be processed, the user can have the image reading apparatus 100 to restart the conveying and imaging of the medium according to appropriate settings. Thus, the image reading apparatus 100 can enhance user convenience.

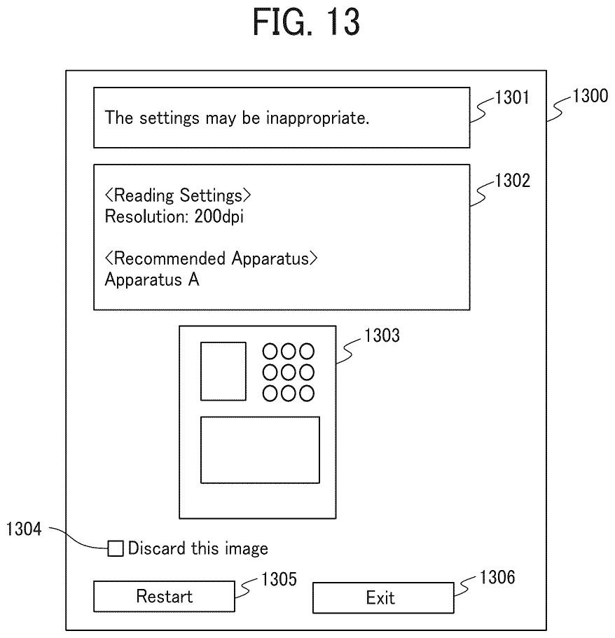

FIG. 13 is a schematic diagram illustrating an example of notification data 1300 that is output when it is determined that the setting value designated by the user does not match the characteristic of the input image.

As illustrated in FIG. 13, the notification data 1300 includes, for example, summary information 1301, detailed information 1302, an input image 1303, a delete button 1304, a restart button 1305, and an exit button 1306. The summary information 1301 indicates the determination result by the determination unit 145, that is, indicates that the setting value designated by the user does not match the characteristic of the input image. The detailed information 1302 indicates a combination of a setting item and a setting value determined not to match the characteristic of the input image, and, for example, a recommended apparatus or recommended software that supports a recommended setting that matches the characteristic of the input image. The recommended setting is the setting value that is identified in step S112 and that matches the characteristic of the input image. The recommended apparatus or recommended software is an image reading apparatus or software that is identified in step S114 and that supports the setting value that matches the characteristic of the input image.

In this way, the control unit 141 notifies the user of the setting value that matches the characteristic of the input image for the setting item that is determined not to match the characteristic of the input image. Accordingly, the user can recognize the appropriate setting for a medium included in the input image. The conveyance and imaging of media are restarted according to such an appropriate setting. Thus, the image reading apparatus 100 can enhance user convenience.

Further, the control unit 141 notifies information regarding another image reading apparatus or another software that supports the setting that matches the characteristic of the input image. Accordingly, the user can recognize an image reading apparatus or software that can generate an image suitable for a medium included in the input image, and can acquire a desired image using the image reading apparatus or the software. Thus, the image reading apparatus 100 can enhance user convenience.

The input image 1303 is an input image for which it is determined that the setting value designated by the user does not match the characteristic of the input image. The user can check the appropriateness of the designated setting value by viewing the input image 1303. The delete button 1304 is a button for designating deletion of an image corresponding to the input image 1303. The user can delete the input image 1303 and/or a processed image generated based on the input image 1303 by using the delete button 1304. The restart button 1305 is a button for restarting conveying media. By pressing the restart button 1305 after taking out the conveyed medium, the user can restart conveying and imaging the remaining media according to the setting information that is currently set. The exit button 1306 is a button for ending the media reading process. By pressing the exit button 1306, the user can cancel the conveying and imaging of the remaining media according to the setting information that is currently set.

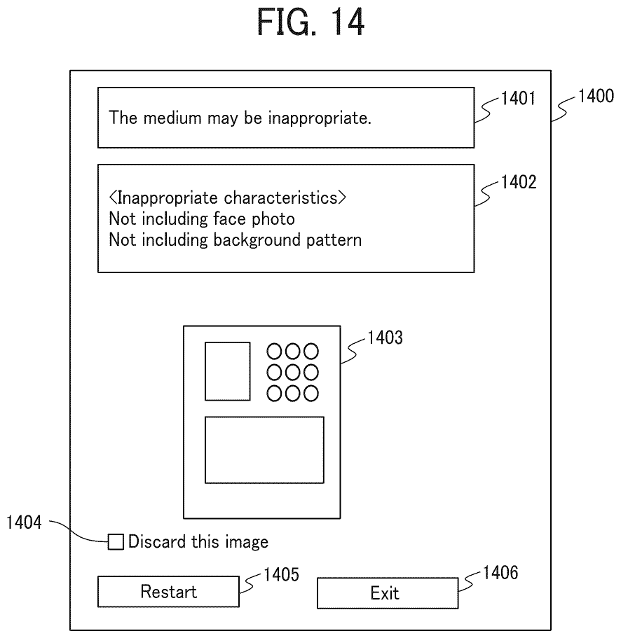

FIG. 14 is a schematic diagram illustrating an example of notification data 1400 that is output when it is determined that the input image does not have the characteristic designated by the user.

As illustrated in FIG. 14, the notification data 1400 includes, for example, summary information 1401, detailed information 1402, an input image 1403, a delete button 1404, a restart button 1405, and an exit button 1406. The summary information 1401 indicates the determination result by the determination unit 145, that is, indicates that the input image does not have the characteristic designated by the user. The detailed information 1402 indicates image characteristics that are determined not to be included in the input image.

In this way, the control unit 141 notifies the user of the image characteristic determined not to be included in the input image. Accordingly, the user can check whether the imaged medium is a medium to be processed. Thus, the image reading apparatus 100 can enhance user convenience.

The input image 1403 is an input image determined not to have the characteristic designated by the user. By viewing the input image 1403, the user can check whether the imaged medium is a medium to be processed. The delete button 1404 is a button for designating deletion of an image corresponding to the input image 1403. The user can delete the input image 1403 and/or a processed image generated based on the input image 1403 by using the delete button 1404. The restart button 1405 is a button for restarting conveying media. By pressing the restart button 1405, the user can restart conveying and imaging the remaining media. The exit button 1406 is a button for ending the media reading process. By pressing the exit button 1406, the user can cancel the conveying and imaging of the remaining media.

Subsequently, the control unit 141 waits until an instruction to restart or finish the conveying and imaging of the medium is input by the user using the first input device 105 or the information processing apparatus 200 and an instruction signal is received from the first input device 105 or the first communication device 122 (step S116). When the restart button 1305 or the restart button 1405 is pressed by the user, the control unit 141 receives the instruction signal from the first input device 105 or the first communication device 122 that instructs to restart the conveying and imaging the media. By contrast, when the exit button 1306 or the exit button 1406 is pressed by the user, the control unit 141 receives a first instruction signal from the first input device 105 or the first communication device 122 that instructs to finish the conveying and imaging of the media. Further, when the user designates deletion of an image using the delete button 1304 or the delete button 1404, each of the instruction signals include an instruction to delete an image.

In response to receiving the instruction signal, the control unit 141 determines whether the instruction signal includes an instruction to delete an image (step S117). When the instruction signal does not include the instruction to delete an image, the control unit 141 does not perform any particular process, and the operation proceeds to step S119.

By contrast, when the instruction signal includes the instruction to delete an image, the control unit 141 deletes the input image obtained by imaging a medium currently conveyed from the first storage device 130 (step S118).

Subsequently, the control unit 141 determines whether the instruction signal instructs to restart the conveying and imaging of the media or the instruction signal instructs to finish the conveying and imaging of the media (step S119). When the instruction signal instructs to finish the conveying and imaging of the media, the control unit 141 finishes the media reading process without conveying the remaining media.

By contrast, when the instruction signal instructs to restart the conveying and imaging of the media, the control unit 141 re-drives the motor 121 to re-rotate the feed roller 112, the separation roller 113, the first conveyance roller 114, the second conveyance roller 115, the third conveyance roller 118, and/or the fourth conveyance roller 119. Thus, the control unit 141 re-feeds and re-conveys the media (step S120).

Subsequently, the control unit 141 processes the input image according to the setting information designated by the user to generate a processed image, and stores the processed image in the first storage device 130 in association with the media number. The control unit 141 outputs the generated processed image by transmitting the processed image to the information processing apparatus 200 via the first communication device 122 (step S121). In response to receiving the processed image from the image reading apparatus 100 via the second communication device 203, the information processing apparatus 200 displays the received processed image on the second display device 202. When it is determined in step S117 that the instruction signal includes an instruction to delete an image, the control unit 141 does not generate the processed image.

Regarding a setting item for which the setting value is set to “automatic,” the control unit 141 generates a processed image according to a setting value that matches the characteristic information corresponding to each setting item. For example, regarding a media size, the control unit 141 cuts out an area that has the size identified as the characteristic information and includes the medium from the input image to generate the processed image. Further, regarding color, the control unit 141 generates a color image as the processed image when the color components identified as the characteristic information is color. When the color components identified as the characteristic information is black and white, the control unit 141 generates a gray scale image or a binary image as the processed image. Furthermore, regarding a setting item for which multiple setting values are set, the control unit 141 generates the processed image according to a setting value that matches the characteristic information corresponding to each setting item among the multiple setting values being set.

Subsequently, the control unit 141 determines whether a medium remains on the medium tray 103 on the basis of the first media signal received from the first media sensor 111 (step S122). When a medium remains on the medium tray 103, the control unit 141 increments the media number of the medium to be conveyed by one and sets the media number of the media to be conveyed next. Subsequently, the control unit 141 returns the operation to step S107 and repeats the processes of steps S107 to step S122.

By contrast, when no media remains on the medium tray 103, the control unit 141 stops the motor 121 to stop the feed roller 112, the separation roller 113, the first conveyance roller 114, the second conveyance roller 115, the third conveyance roller 118, and the fourth conveyance roller 119 (step S123). Thus, the control unit 141 stops conveying the media. Then, the control unit 141 ends the image reading process.

The processes of steps S103 and S109, the processes of steps S104 and S110, the process of step S112, the processes of steps S113 to S114, and/or the process of step S115 may be omitted.

Alternatively, the process of step S111 may be omitted, and the control unit 141 may output the notification data after stopping the conveyance of media in step S115. In this case, the control unit 141 generates the notification data so that a list of input images for which the setting value designated by the user does not match the characteristic of the input image and/or input images determined not to have the characteristic designated by the user are displayed along with the corresponding media number and detailed information.

The process in step S121 may be performed before the notification data is output in step S115. In this case, when it is determined that the instruction signal includes an instruction to delete an image in step S117, the control unit 141 deletes the processed image together with the input image in step S118. Further, the control unit 141 transmits a request signal requesting deletion of the processed image to the information processing apparatus 200 via the first communication device 122. In response to receiving the request signal from the image reading apparatus 100 via the second communication device 203, the second processing circuit 220 of the information processing apparatus 200 deletes the corresponding processed image from the second storage device 210.

As described above in detail, the image reading apparatus 100 receives from the user a designation of a setting item for which determination is performed as to whether a setting value matches the characteristic of the input image. When the setting value of the designated setting item does not match the characteristic of the input image, the image reading apparatus 100 notifies the user. Accordingly, when the setting value of the setting item designated by the user is not appropriate, the image reading apparatus 100 can stop the image generation process or notify the user that the setting value is not appropriate. Thus, the image reading apparatus 100 can enhance user convenience.

Further, the image reading apparatus 100 determines whether the setting value matches the characteristic of the input image not for all the setting items but only for the setting item designated by the user. Accordingly, the image reading apparatus 100 can prevent the image generation process from being erroneously stopped or the notification to the user from being erroneously performed even when the setting value is appropriate. Thus, the image reading apparatus 100 prevent the user from taking time and efforts. Further, since the image reading apparatus 100 determines whether the setting value matches the characteristic of the input image not for all the setting items but only for the setting item designated by the user, increases in the processing load and the processing time for the image determination is prevented.

Furthermore, each time an input image is generated, the image reading apparatus 100 determines whether the setting value matches the characteristic of the input image, and immediately stops the image generation process or performs notification to the user when the setting value does not match the characteristic of the input image. Accordingly, the user can immediately take appropriate measures when an unexpected medium is included in media to be processed by mistake. The image reading apparatus 100 can reduce rework in the user's work and enhance user convenience.

A bundle of media of mixed media types may be conveyed collectively. For example, a photograph is mixed in a bundle of forms. In this case, an image may be generated from a captured image of another type of medium (for example, a photograph) according to the settings suitable for a particular type of medium (for example, binary values suitable for forms). In such a case, the user has to take out a medium that is imaged with inappropriate settings from the bundle of media, have the bundle of media re-conveyed and re-imaged, and replace the image generated with the inappropriate settings with the newly generated image. Further, the user may be unaware of the medium imaged with inappropriate settings, and therefore an image generated with inappropriate settings may remain. When the setting information does not match the characteristic of the input image, the image reading apparatus 100 suspends conveying subsequent media, allowing the user to take measures such as taking out the medium at that timing. Further, when the setting value does not match the characteristic of the input image, the image reading apparatus 100 notifies the user that the setting value does not match the characteristic of the input image reading apparatus. Accordingly, the user can have the image reading apparatus 100 to restart the conveying and imaging of the medium according to appropriate settings. Thus, the image reading apparatus 100 can enhance user convenience.

Further, even a user having little knowledge or low skill in the image reading process can appropriately select a setting value for generating a desired image. This allows the image reading apparatus 100 to prevent the occurrence of rework in the image reading process due to the use of inappropriate settings and minimize the decrease in the work efficiency or the work quality of the user.

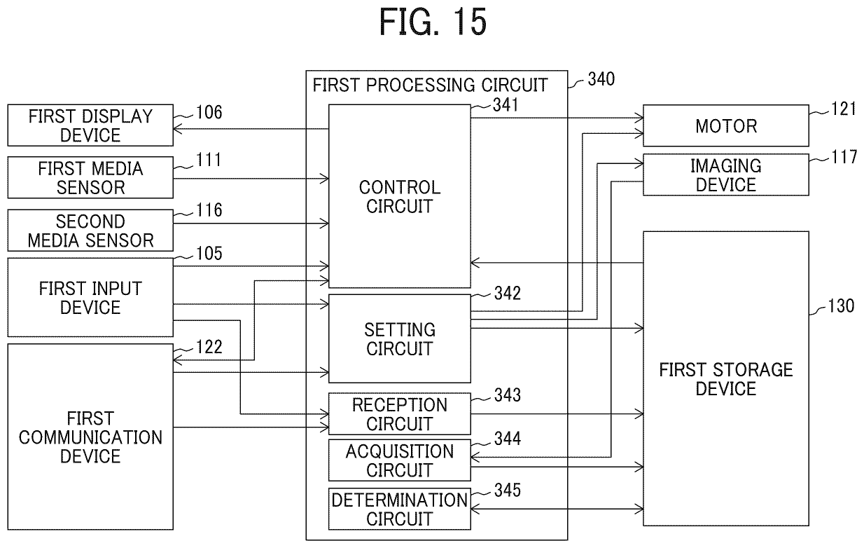

FIG. 15 is a block diagram schematically illustrating a configuration of a first processing circuit 340 in an image reading apparatus according to another embodiment.

The first processing circuit 340 is used instead of the first processing circuit 140 and performs, for example, an image reading process. The first processing circuit 340 includes a control circuit 341, a setting circuit 342, a reception circuit 343, an acquisition circuit 344, and a determination circuit 345.

The control circuit 341 is an example of a control unit and functions in the same or substantially the same manner as the control unit 141. The control circuit 341 receives the operation signal from the first input device 105 or the first communication device 122, the first media signal from the first media sensor 111, and the second media signal from the second media sensor 116. Further, the control circuit 341 reads a determination result indicating whether the setting value designated by the user matches the characteristic of the input image and a determination result indicating the input image has the characteristic designated by the user from the first storage device 130. The control circuit 341 controls the motor 121 on the basis the information received or read. Further, the control circuit 341 reads, for example, the input image, from the first storage device 130, generates the notification data, and outputs the notification data to the first display device 106 or the first communication device 122. Furthermore, the control circuit 341 generates a processed image on the basis of the input image and outputs the processed image to the first communication device 122.

The setting circuit 342 is an example of a setting unit and functions in the same or substantially the same manner as the setting unit 142. The setting circuit 342 receives the setting information designated by the user from the first input device 105 or the first communication device 122, sets the setting information to the first storage device 130, and configures the settings of the imaging device 117 or the motor 121.

The reception circuit 343 is an example of a reception unit and functions in the same or substantially the same manner as the reception unit 143. The reception circuit 343 receives the setting item designated by the user on which the image determination is to be performed and the image characteristic from the first input device 105 or the first communication device 122 and sets the received setting item and image characteristic in the first storage device 130.

The acquisition circuit 344 is an example of an acquisition unit and functions in the same or substantially the same manner as the acquisition unit 144. The acquisition circuit 344 acquires the input image from the imaging device 117 and stores the acquired input image in the first storage device 130.

The determination circuit 345 is an example of a determination unit and functions in the same or substantially the same manner as the determination unit 145. The determination circuit 345 reads the input image, the setting item designated by the user on which the image determination is to be performed, the setting value of the user-designated setting item, and the image characteristic from the first storage device 130. The determination circuit 345 determines whether the setting value of the item designated by the user matches the characteristic of the input image and whether the input image has the characteristic designated by the user on the basis of the read information and stores the determination results in the first storage device 130.

As described above in detail, the image reading apparatus using the first processing circuit 340 also can enhance user convenience.

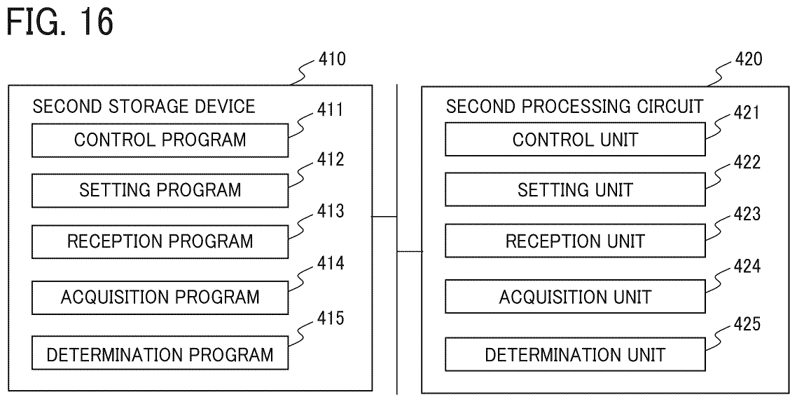

FIG. 16 is a block diagram schematically illustrating configurations of a second storage device 410 and a second processing circuit 420 in an information processing apparatus according to still another embodiment.

As illustrated in FIG. 16, the second storage device 410 stores a control program 411, a setting program 412, a reception program 413, an acquisition program 414, and a determination program 415. These programs are functional modules implemented by software operating on a processor. The second processing circuit 420 reads the programs stored in the first storage device 130 and operates according to the read programs, thereby functioning as a control unit 421, a setting unit 422, a reception unit 423, an acquisition unit 424, and a determination unit 425.

The control unit 421, the setting unit 422, the reception unit 423, the acquisition unit 424, and the determination unit 425 have the same or substantially the same functions as the control unit 141, the setting unit 142, the reception unit 143, the acquisition unit 144, and the determination unit 145 of the image reading apparatus 100, respectively. The second storage device 410 stores the data stored by the first storage device 130. The processes of steps S101 to S104, S106 to S120, and S123 of the image reading process are performed by the setting unit 422, the reception unit 423, the acquisition unit 424, and the determination unit 425.

In steps S101, the control unit 421 waits until the control unit 421 receives an operation signal instructing the reading of media from the second input device 201. The operation signal is output when the user inputs an instruction to read media using the second input device 201. The control unit 421 displays the reception screen on the second display device 202 and receives the instructions from the user via the second input device 201. The control unit 421 transmits the received operation signal to the image reading apparatus 100 via the second communication device 203.

In steps S106 and S120, the control unit 421 transmits a request signal that requests to drive the motor 121 to the image reading apparatus 100 via the second communication device 203. The control unit 141 of the image reading apparatus 100 receives the request signal from the information processing apparatus 200 via the first communication device 122 and drives the motor 121 according to the received request signal. Thus, the control unit 421 feeds and conveys the media.

In step S107, the acquisition unit 144 transmits the input image to the information processing apparatus 200 via the first communication device 122. The acquisition unit 424 acquires the input image by receiving the input image from the image reading apparatus 100 via the second communication device 203.

In steps S111 and S123, the control unit 421 transmits a request signal that requests to stop the motor 121 to the image reading apparatus 100 via the second communication device 203. The control unit 141 of the image reading apparatus 100 receives the request signal from the information processing apparatus 200 via the first communication device 122 and stops the motor 121 according to the received request signal. Accordingly, the control unit 421 stops feeding and conveying the media and controls the image reading apparatus 100 that has generated the input image to stop the image generation process.

In step S115, the control unit 421 outputs the notification data by displaying the notification data on the second display device 202 or transmitting the notification data to another information processing apparatus 200 via the second communication device 203. In step S116, the control unit 421 receives the instruction signal from the second input device 201 or from another information processing apparatus 200 via the second communication device 203. In step S121, the control unit 421 outputs the processed image by displaying the processed image on the second display device 202.

Some of the processes performed by the units of the information processing apparatus described above may be performed by the corresponding units of the image reading apparatus.

As described above in detail, the image processing system can enhance user convenience also when the information processing apparatus performs some of the image reading processes.

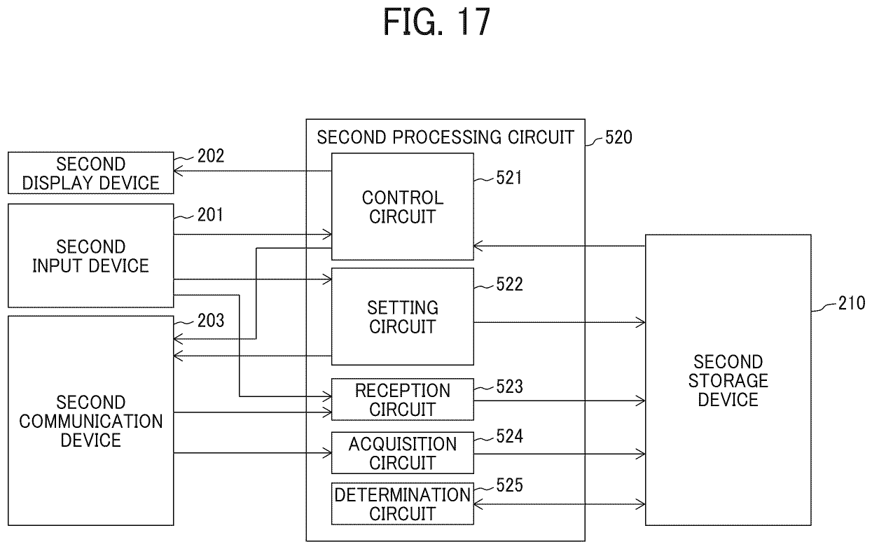

FIG. 17 is a block diagram schematically illustrating a configuration of a second processing circuit 520 in an information processing apparatus according to still another embodiment.

The second processing circuit 520 is used instead of the second processing circuit 420 and performs, for example, an image reading process. The second processing circuit 520 includes a control circuit 521, a setting circuit 522, a reception circuit 523, an acquisition circuit 524, and a determination circuit 525.

The control circuit 521 is an example of the control unit and functions in the same or substantially the same manner as the control unit 421. The control circuit 521 receives an operation signal from the second input device 201 and outputs the received operation signal to the second communication device 203. Further, the control circuit 521 reads, for example, the input image, a determination result indicating whether the setting value designated by the user matches the characteristic of the input image, and a determination result indicating the input image has the characteristic designated by the user from the second storage device 210. The control circuit 521 generates the notification data on the basis of the read information and outputs the generated notification data to the second display device 202 or the second communication device 203. Furthermore, the control circuit 521 generates a processed image on the basis of the input image and outputs the processed image to the second display device 202.

The setting circuit 522 is an example of the setting unit and functions in the same or substantially the same manner as the setting unit 422. The setting circuit 522 receives the setting information designated by the user from the second input device 201, stores the setting information in the second storage device 210, and outputs the setting information to the second communication device 203.

The reception circuit 523 is an example of the reception unit and functions in the same or substantially the same manner as the reception unit 423. The reception circuit 523 receives the setting item designated by the user on which the image determination is to be performed and the image characteristic from the second input device 201 or the second communication device 203 and sets the received setting item and image characteristic in the second storage device 210.

The acquisition circuit 524 is an example of the acquisition unit and functions in the same or substantially the same manner as the acquisition unit 424. The acquisition circuit 524 receives the input image from the second communication device 203 and stores the input image in the second storage device 210.

The determination circuit 525 is an example of the determination unit and functions in the same or substantially the same manner as the determination unit 425. The determination circuit 525 reads the input image, the setting item designated by the user on which the image determination is to be performed, the setting value of the user-designated setting item, and the image characteristic. The determination circuit 345 determines whether the setting value of the item designated by the user matches the characteristic of the input image and whether the input image has the characteristic designated by the user on the basis of the read information and stores the determination results in the second storage device 210.

As described above in detail, the information processing apparatus using the second processing circuit 520 also can enhance user convenience.

Although the preferred embodiments have been described above, the embodiments are not limited thereto. For example, the control unit 141 may receive an instruction other than the instruction to restart or finish the conveying and imaging of the media in step S116. For example, the control unit 141 receives an instruction to change the setting value from the user. In response to receiving the instruction to change the setting value, the control unit 141 changes the setting value of the setting item that does not match the characteristic of the input image to a setting value that matches the characteristic of the input image or a setting value newly designated by the user. The control unit 141 generates a processed image from the input image generated this time according to the changed setting value and/or generates an input image obtained by imaging a medium to be conveyed thereafter and a processed image. Accordingly, the image reading apparatus 100 can reduce the user's time and efforts when the setting value is changed and the medium is re-conveyed and re-imaged. Thus, the image reading apparatus 100 can enhance user convenience.

The control unit 141 may receive an instruction to delete an image from the user. In response to receiving the instruction to delete an image, the control unit 141 deletes the input image (and the processed image) generated this time.

The determination unit 145 may determine whether the setting value designated by the user matches the characteristic of the input image based on information other than the input image. For example, the determination unit 145 may identify the size of a medium on the basis of the difference between a time when the leading end of the medium pass through the second media sensor 116 and a time when the trailing end of the medium pass through the second media sensor 116. Alternatively, the image reading apparatus 100 may include another imaging device different from the imaging device 117, and the determination unit 145 may identify the characteristic information of an image on the basis of the image generated by imaging a medium using such an another imaging device.

Further, the image reading apparatus may have a so-called U-turn path, feed the media placed on the medium tray sequentially from the top, and discharge the media to the ejection tray.

Enhancing user convenience is required in an image processing apparatus.

According to one aspect of the present disclosure, an image processing apparatus, an image processing system, an image processing method, and a control program can enhance the convenience for a user.

In one aspect, a control program for controlling a computer includes a plurality of program codes, which, when executed by the computer, causes the computer to perform a method. The method includes setting a setting value for each of a plurality of setting items regarding an input image generation process. The method includes receiving designation of one or more setting items on which determination is to be performed as to whether the setting value matches a characteristic of an input image obtained by imaging a medium from among the plurality of setting items. The method includes acquiring the input image. The method includes performing determination of whether the setting value matches the characteristic of the input image for each of the designated one or more setting items. The method includes notifying information regarding a result of the determination or controlling an apparatus that generated the input image to stop an image generation process when the result of the determination indicates that the setting value does not match the characteristic of the input image.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, ASICs (“Application Specific Integrated Circuits”), FPGAs (“Field-Programmable Gate Arrays”), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of a FPGA or ASIC.

1. An image processing apparatus, comprising circuitry configured to:
set a setting value for each of a plurality of setting items regarding an input image generation process;
receive designation of one or more setting items on which determination is to be performed as to whether the setting value matches a characteristic of an input image obtained by imaging a medium from among the plurality of setting items;
acquire the input image;
perform determination of whether the setting value matches the characteristic of the input image for each of the designated one or more setting items; and
notify information regarding a result of the determination or control an apparatus that generated the input image to stop an image generation process when the result of the determination indicates that the setting value does not match the characteristic of the input image.

2. The image processing apparatus of claim 1, wherein
the circuitry is configured to receive, for each of the plurality of setting items, designation of whether to perform the determination.

3. The image processing apparatus of claim 1, wherein the circuitry is configured to:
further set a plurality of setting values for a particular setting item; and
in a case where the particular setting item is designated as a setting item on which the determination is to be performed, notify the information regarding the result of the determination or control the apparatus that generated the input image to stop the image generation process when it is determined that none of the plurality of setting values matches the characteristic of the input image.

4. The image processing apparatus of claim 1, wherein the circuitry is configured to:
further set a plurality of sets each of which includes a setting value for each of a predetermined number of setting items; and
in a case where the predetermined number of setting items included in the plurality of sets are designated as setting items on which the determination is performed, notify the information regarding the result of the determination or control the apparatus that generated the input image to stop the image generation process when it is determined that the setting value for each of the predetermined number of setting items does not match the characteristic of the input image for any of the plurality of sets.

5. The image processing apparatus of claim 1, wherein the circuitry is configured to:
further receive designation of a characteristic of an image;
further determine whether the input image has the designated characteristic; and
notify the information regarding a determination result or controls the apparatus that generated the input image when it is determined that the input image does not have the designated characteristic.

6. The image processing apparatus of claim 5, wherein
the designated characteristic of the image is not defined in advance in the image processing apparatus.

7. An image processing system including an image reading apparatus and an information processing apparatus, the image processing system comprising circuitry configured to:
set a setting value for each of a plurality of setting items regarding an input image generation process;
receive designation of one or more setting items on which determination is to be performed as to whether the setting value matches a characteristic of an input image obtained by imaging a medium from among the plurality of setting items;
acquire the input image;
perform determination of whether the setting value matches the characteristic of the input image for each of the designated one or more setting items; and
notify information regarding a result of the determination or control an apparatus that generated the input image to stop an image generation process when the result of the determination indicates that the setting value does not match the characteristic of the input image.

8. An image processing method, comprising:
setting a setting value for each of a plurality of setting items regarding an input image generation process;
receiving designation of one or more setting items on which determination is to be performed as to whether the setting value matches a characteristic of an input image obtained by imaging a medium from among the plurality of setting items;
acquiring the input image;
performing determination of whether the setting value matches the characteristic of the input image for each of the designated one or more setting items; and
notifying information regarding a result of the determination or controlling an apparatus that generated the input image to stop an image generation process when the result of the determination indicates that the setting value does not match the characteristic of the input image.
